(19) United States
(12) Patent Application Publication
(10) Pub. No.: US 2026/0002391 A1
(43) Pub. Date: Jan. 1, 2026

(54) LOCK HOLDER FOR A MOTOR VEHICLE DOOR LOCK

(71) Applicant: Kiekert Aktiengesellschaft, Heiligenhaus (DE)

(72) Inventors: Ömer INAN, Dorsten (DE); Peter SZEGENY, Engelskirchen (DE); Holger SCHIFFER, Meerbusch (DE); Michael SCHOLZ, Essen (DE); Thorsten BENDEL, Oberhausen (DE)

(73) Assignee: Kiekert Aktiengesellschaft, Heiligenhaus (DE)

(21) Appl. No.: 18/880,691

(22) PCT Filed: Jun. 2, 2023
(86) PCT No.: PCT/DE2023/100418

§ 371 Date: Jan. 2, 2025

(30) Foreign Application Priority Data
Jul. 11, 2022 (DE) 10 2022 117 242.2

(51) Int. Cl. E05B 85/04

(52) U.S. Cl. CPC E05B 85/045

(57) ABSTRACT

The invention relates to a lock holder (1) for a motor vehicle door lock, having a lock holder plate (2) and a lock holder bracket (3) which is secured to the lock holder plate (2). The lock holder bracket (3) is formed with a locking pin (7), a central piece (9), and a connecting pin (10), and the central piece (9) is equipped with a projection (8) in the direction of the longitudinal axis of the central piece (8). The lock holder (1) is designed in at least two parts.

The invention relates to a lock holder for a motor vehicle door lock, having a lock holder plate and a lock holder bracket which is secured to the lock holder plate, wherein the lock holder bracket is formed with a locking pin, a central piece, and a connecting pin, and the central piece is equipped with a projection in the direction of the longitudinal extension of the central piece.

The lock holder generally interacts with a locking mechanism of an associated motor vehicle door lock. The lock holder and motor vehicle door lock generally define the motor vehicle door locking means. In conjunction with the locking mechanism in the motor vehicle door lock, the lock holder ensures a secure and reliable closure of the associated motor vehicle door. For this purpose, the lock holder is usually connected to a motor vehicle body, for example a B or C pillar of the associated motor vehicle body. The motor vehicle door lock, on the other hand, is located in the motor vehicle door to be locked. In principle, this can also be reversed.

Due to the primary closing function of the lock holder in conjunction with the locking mechanism in the motor vehicle door lock, this is, on the one hand, a particularly safety-relevant component which, on the other hand, is exposed to particular loads in particular in the event of an accident. In fact, the protection of vehicle occupants in the event of a side impact depends substantially on how reliably the lock holder and the locking mechanism interacting therewith are capable of absorbing the forces acting thereon. The primary concern here is that the motor vehicle door remains closed so that safety devices provided in or on the motor vehicle door, such as side airbags, side impact protection, etc., can have the desired effect.

The forces to be absorbed via the interaction between the motor vehicle door lock and the lock holder act directly between the locking mechanism contained in the motor vehicle door lock and the locking pin of the lock holder bracket which engages with the locking mechanism. The locking mechanism is formed from a catch and at least one pawl, wherein after engagement of the catch, during a closing movement of the door element, the pawl engages in the catch in the striker of the lock holder and prevents the door element from opening. The locking mechanism can have a pre-ratchet and a main ratchet which can be present in the door lock depending on the door element.

Depending on the embodiment of the locking mechanism, the particular ratchet position, i.e., main ratchet or pre-ratchet, can be provided with an opening or closing moment, so that a blocking lever can be used to secure the ratchet position. In order to be able to absorb the high forces that occur in the event of an accident, the locking mechanism parts are made at least in part from a metal material, mounted in metal pivots and held on a metal lock plate in the vehicle door lock.

In the prior art, various approaches have already been pursued to further develop such lock holders so that they can absorb far more forces than before in the event of a crash, without tearing off or general mechanical damage occurring or being able to occur. In fact, with regard to the lock holder, material deformations and tears are often observed in practice, in particular at the transition from the lock holder bracket to the lock holder plate.

In order to increase the forces which can be absorbed by the lock holder, various approaches have become known. There are various approaches to providing the lock holder or its lock holder bracket with different cross-sectional thicknesses, as described for example in EP 2 031 158 A2, or to specify an elongation of the lock holder by means of an indentation, as disclosed for example in DE 10 2010 021 677 A1. However, this does not adequately reflect the loads which actually occur in practice and the associated cracking behavior of the lock holder in the event of a crash or extreme forces.

It has become apparent that the connection between the lock holder bracket and the lock holder plate is particularly important.

DE 10 2014 006 857 A1 discloses a lock holder for a motor vehicle door lock, which lock holder has a lock holder plate and a lock holder bracket attached thereto, wherein the lock holder bracket is designed with a locking pin, a central piece and a connecting pin. To strengthen the connection between the lock holder bracket and the lock holder plate, the publication proposes that the lock holder bracket be positively connected to the lock holder plate via at least one material-thickened region. To ensure a positive connection, the part of the lock holder bracket or the locking pin and/or the connecting pin which protrudes beyond the lock holder plate is compressed. As a result of the compression process, the lock holder plate is also provided with a bulge which ensures that compression caps created on the underside of the lock holder plate as a result of the compression process can abut at a distance from the locking pin on the one hand and the connecting pin on the other hand in relation to the body.

The solutions known from the prior art have generally proven themselves, but are reaching their limits with newer developments in the automotive industry. The use of batteries in hybrid or electric vehicles increases the loads caused in the event of an accident. The batteries present in the motor vehicle increase the total weight of the vehicle many times over, so that the loads on the locking mechanism and the lock holder in the event of an accident are also increased. Consequently, approaches must be found to increase the strength of the lock holder. This is where the invention starts.

The object of the invention is to provide an improved lock holder for a motor vehicle door lock. In particular, it is an object of the invention to improve the load capacity of the lock holder and to increase the tear resistance of the system consisting of the lock and the lock holder.

According to the invention, the object is achieved by the features of independent claim 1. Advantageous embodiments of the invention are specified in the dependent claims. It should be noted, however, that the embodiments described below are not restrictive; rather, any variation of the features described in the description and the dependent claims is possible.

According to claim 1, the object of the invention is achieved in that a lock holder for a motor vehicle door lock is provided, having a lock holder plate, a lock holder bracket which is secured to the lock holder plate, wherein the lock holder bracket is formed with a locking pin, a central piece and a connecting pin, and the central piece is equipped with a projection in the direction of a longitudinal axis of the central piece, wherein the lock holder is formed in at least two parts. The design according to the invention of the lock holder now makes it possible to design the lock holder bracket so that it can be individually adapted to the loads and, in particular, to the extreme loads in the event of an accident. The individual loads in the event of an accident are particularly relevant to safety, as it must be ensured that the doors, flaps or hoods remain closed, in particular in the event of an accident. The side doors are particularly important because the occupants of the motor vehicle must be protected. Other safety systems, such as seatbelts and airbags, can only be fully effective when the door is securely closed.

The loads during a crash are extremely high and are simulated by tensile tests when designing the lock holder. The lock holder is subjected to a tensile test until it breaks in order to determine whether the defined specifications are met and to identify weak points so that the lock holder can be designed individually. This is where the invention starts and shows a way to improve the load capacity of the lock holder. The projection in the direction of the longitudinal axis of the central piece allows the catch to be supported in the locking mechanism, wherein the two-part construction supports the possibility of cost-effective production.

As already indicated above, the lock holder according to the invention not only relates to a side door, but can also be used in the region of a hood, tailgate, sliding door, cover, foldable seats, etc., in other words wherever components used on the motor vehicle in a pivoting or sliding manner must be held securely in their position.

Basically, the lock holder has a lock holder plate which is designed as a base for the lock holder bracket and which preferably has at least two boreholes by means of which the lock holder can be secured to the motor vehicle or to the movable component. The openings in the lock holder plate preferably have a conical countersink so that a flat surface with the lock holder plate can be achieved by means of suitable screws having a conical head. The lock holder plate can additionally have a bevel so that the rivet heads of the lock holder bracket can be accommodated in the bevel so that, in turn, at least a partial region of the lock holder plate can be secured flat to the body. The bevel then accommodates the corresponding rivet heads of the lock holder bracket.

Preferably, the lock holder bracket can be secured to the lock holder plate as a separate component, in particular non-detachably. The two-part construction and, in particular, the separation between the lock holder bracket and the lock holder plate allows for individual adjustment of the loads. A simple construction is possible because the lock holder plates are produced individually and can be designed, for example, as a stamped and bent piece, which can be advantageous in particular in mass production. The lock holder bracket can be secured to the lock holder plate, which also allows for advantageous production. The design of a lock holder bracket with a projection in the direction of a longitudinal axis of the central piece allows an extended engagement surface to be created between the lock holder bracket and the catch engaging with the lock holder bracket. When the locking mechanism is closed, the catch engages with the locking pin and rotates about the locking pin. Finally, i.e., in the main ratchet position, the catch abuts the locking pin.

If, in the event of an accident, the engagement conditions between the catch and the lock holder are shifted, the catch comes into engagement with the central piece because the catch moves over the locking pin toward the central piece. Due to the projection on the central piece, not only the part of the catch which surrounds the locking pin, i.e., the load arm of the catch, comes into engagement with the central piece, but also the part of the catch which is arranged in front of the locking pin, in other words the catch arm of the catch. The catch is therefore supported by both sides of the locking pin, on the one hand in the direction of the central piece and on the other hand in the direction of the protrusion. This means that overall there can be more support when the catch and lock holder work together. This increases the load capacity of the door locking system.

The locking pin is preferably secured to the lock holder plate at a right angle, i.e., in the direction of a normal to the lock holder plate. Starting from the striker, the central piece extends substantially parallel to the lock holder plate, thereby creating an engagement region for the catch in the lock holder bolt. The central piece is followed by the connecting pin, which in turn extends from the central piece to the lock holder plate. The connecting pin can be straight or, at least in regions, bent. However, it is also conceivable that the connecting pin forms a slope from the central piece in the direction of the lock holder plate.

Advantageously and in a further embodiment variant of the invention, the lock holder bracket has a mounting web, in particular a mounting web arranged parallel to the central piece. The mounting web extends along the lock holder plate and abuts the lock holder plate. The mounting web thus has, as does a preferred embodiment of the lock holder plate, a flat extension in the region of the contact surface with the lock holder plate. The lock holder bracket can be connected to the lock holder plate using the mounting web. The mounting web extends parallel to the central piece, creating an opening in the lock holder bracket which can be described as substantially rectangular. Depending on the design of the connecting pin, an alternative opening shape may result, for example if the connecting pin is angled or has an S-shape. Preferably, the central piece and the mounting web have the same cross-sectional areas. This has proven to be particularly advantageous in terms of load capacity. The use of the mounting web increases the resistance to bending stress. Bending stress can act on the locking pin in particular in the longitudinal direction of the vehicle or in the direction of a longitudinal extension. Typically, a coordinate system is placed in a motor vehicle for design purposes. The y-axis represents the longitudinal direction of the vehicle, the x-axis represents the transverse direction of the vehicle and the z-axis represents a vertical axis in relation to the motor vehicle or the ground below the vehicle. The bending stress can thus be increased in particular in the y-and z-directions.

It can also be advantageous if the mounting web is designed with mounting elements. In this case, at least one extension can be formed on the lock holder bracket, which extension then extends through an opening in the lock holder plate and can be non-detachably connected to the lock holder plate, for example by means of a forming process. Preferably, two extensions are formed on the lock holder bracket, which extensions can be connected to the lock holder plate by forming, i.e., riveting. It is also conceivable that three extensions are formed on the lock holder bracket, wherein it is also conceivable according to the invention that, for example, one extension serves as a mounting aid, for example for inserting the lock holder bracket into the lock holder plate. Preferably, the extensions on the lock holder bracket are cylindrical, wherein the extensions can be inserted into boreholes in the lock holder plate.

The lock holder bracket has a contour that can be described as substantially rectangular in shape. The central piece, the connecting pin and the mounting web can have a square shape, whereas the locking pin has a round cross-sectional shape. The locking pin has a round shape because the locking pin engages with the catch and by means of a rotating movement of the catch. In contrast, the projection, the central piece, the connecting pin and the mounting web have a square shape, which has proven to be particularly advantageous with regard to bending stress on the lock holder.

Advantageously, the projection forms a contact surface for a catch. The projection extends from the central piece beyond the locking pin, wherein the projection has a cross-sectional shape corresponding to the central piece. The projection forms a contact surface for the catch. The projection extends so far beyond the locking pin that the projection engages with a catch arm of the catch. Preferably, the projection extends partially beyond the catch arm. Consequently, in the event of extreme stress, i.e., in the event of an accident, the catch can also come into contact with the projection. This is particularly advantageous in relation to a vehicle's transverse direction, because the catch abuts not only the central piece via the load arm, but also on the projection by means of the catch arm. The locking pin is therefore surrounded circumferentially in some regions, i.e., over an angle of more than 180°, preferably up to 270°, so that in addition to the central piece, the projection is also available as a contact surface for the catch.

The projection and the central piece form a common contact surface for the catch. For this purpose, the central piece and the projection can advantageously be arranged on a common plane, at least in relation to the contact surface of the catch. The central piece and the projection thus form a common contact surface for the catch. The central piece and the projection also extend laterally beyond the locking pin, so that circumferential contact with the catch can also be achieved. The central piece and the projection can provide a load surface which allows the catch to abut flat in the event of extreme loads, allowing a significant increase in the load capacity of the motor vehicle door lock to be achieved.

It can also be advantageous if the lock holder bracket is designed as one piece. The one-piece design of the lock holder bracket offers the advantage that an increased load capacity can be achieved in the lock holder bracket. In particular, there are no stress peaks in the transition region between the different regions of the lock holder bracket because a one-piece construction has an optimized force line path.

The invention is explained in more detail below with reference to the accompanying drawings on the basis of a preferred exemplary embodiment. However, the principle applies that the exemplary embodiment does not limit the invention, but is merely an advantageous embodiment of the invention. The features depicted can be implemented individually or in combination with further features of the description as well as what is claimed-individually or in combination.

In the figures:

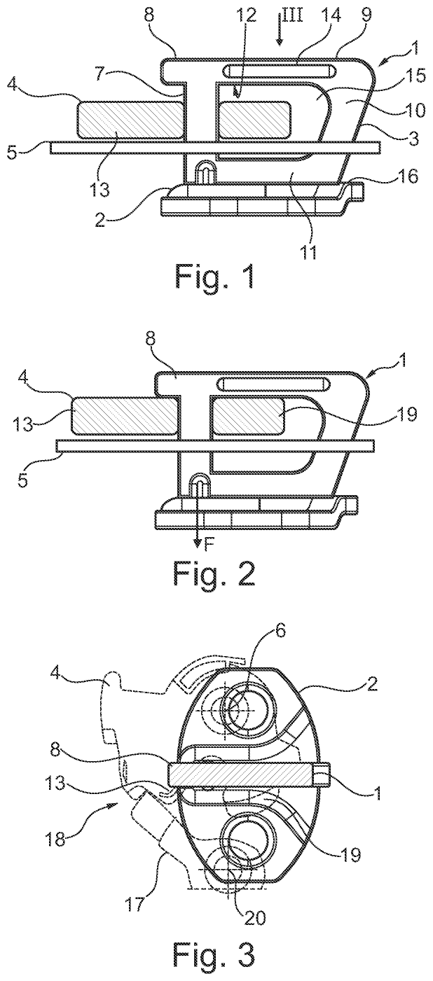

FIG. 1 is a side view of a lock holder designed according to the invention in conjunction with a catch and a lock case,

FIG. 2 shows the lock holder according to FIG. 1 in the event of an external force, such as an accident, and

FIG. 3 is a plan view of the lock holder according to the invention from the direction of arrow III in FIG. 1.

FIG. 1 is a side view of a lock holder 1 designed according to the invention. The lock holder 1 has a lock holder plate 2 and a lock holder bracket 3. The lock holder 1 is shown in combination with a catch 4 and a lock case 5. FIG. 1 shows a main ratchet position, i.e., a closed position of the motor vehicle lock, in which the catch 4 extends around the lock holder, wherein the catch 4 is accommodated in the lock case 5 so as to be rotatable about a pivot 6. It should be noted that the pivot 6 is only shown in principle, wherein the pivot 6 is typically arranged in the closed state of the catch 4 as shown in FIG. 3.

In the exemplary embodiment shown, the lock holder bracket 3 is designed as one piece and has a locking pin 7, a projection 8, a central piece 9, a connecting pin 10 and a central web 11. The side view of the lock holder substantially describes a rectangular shape, wherein the rectangular shape is only abstracted by the inclined position of the connecting pin 10. The projection 8 extends from the central piece 9 beyond the locking pin 7, so that a projection 8 beyond the locking pin 7 can be achieved. The lock holder bracket 3 is substantially square in shape; only the locking pin 7 has a cylindrical shape.

The catch 4 surrounds the locking pin 7 circumferentially, so that the locking pin 7 abuts the catch in some regions. It can be clearly seen that a flat contact surface 12 for the catch 4 can be achieved by means of the projection 8 and the central piece 9. In some regions, the projection 8 extends beyond the catch and, in particular, beyond a catch arm 13 of the catch 4. The projection 8 can, for example, protrude 15 mm, preferably 10 mm, and more preferably 8 mm beyond the catch arm 13.

In FIG. 1 and in particular in the central piece 9 of the lock holder bracket 3, an indentation 14 can be seen which has an additional stabilizing effect on the lock holder bracket 3. The indentation 14 extends substantially above an opening 15 formed by the lock holder bracket 3.

The mounting web 11 lies flush with a surface 16 of the lock holder plate 2. As can be clearly seen, the mounting web 11 and the central piece 9 are arranged parallel to each other, just as the catch 4 and the lock case 5 are arranged parallel to the central piece 9, mounting web 11 and lock holder plate 2. The lock case 5 is usually produced as a stamped sheet metal part and carries the locking mechanism consisting of the catch 4 and pawl 17. The locking mechanism 18 comprising the catch 4 and the pawl 17 and the lock case 5 are parts of the motor vehicle door lock. The lock holder 1 is usually attached to the body of the motor vehicle, wherein the motor vehicle lock is arranged in the movable component of the motor vehicle.

FIG. 2 shows the position of the lock holder 1 when a large force F acts on pressure peaks motor vehicle, for example, in an accident. The lock holder 1 is subjected to a force in the direction of arrow F, causing the catch 4 to come into contact with the contact surface 12. The catch therefore abuts the contact surface 12 with its load arm 19 and abuts the projection 8 with its catch arm 13. The projection 8 and the central piece 9 form a common flat contact surface 12 for the catch 4. The projection 8 that extends beyond the catch arm 13 creates a common contact surface for the catch and, in particular, a circumferential contact surface for the catch 4. This increases the load capacity of the lock holder 1, which in turn is an advantage for the increased demands on the locking mechanism 18 and lock holder 1 components.

FIG. 3 is the view of the lock holder 1 according to the invention from the direction of the arrow III. The locking mechanism 18 is shown in a main ratchet position, i.e., the catch 4 is locked in the closed position by means of the pawl 17, which corresponds to an exemplary completely closed door or tailgate. The catch 4 and the pawl 17 can each be pivoted about their pivots 6, 20 so that a ratchet position, i.e. a pre-ratchet position and a main ratchet position, can be assumed.

As can be clearly seen in FIG. 4, the projection 8 projects beyond the catch arm 13 so that in the event of an increased load and a corresponding deformation of the motor vehicle, the projection 8 and the central piece 9 come into contact with the catch. This can result in a significant increase in load.

### LIST OF REFERENCE SIGNS

1 Lock holder
2 Lock holder plate
3 Lock holder bracket
4 Catch
5 Lock case
6,20 Pivot
7 Locking pin
8 Projection
9 Central piece
10 Connecting pin
11 Mounting web
12 Contact surface
13 Catch arm
14 Indentation
15 Opening
16 Surface
17 Pawl
18 Locking mechanism
19 Load arm
F Force

1. A lock holder for a motor vehicle door lock, comprising:
a lock holder plate and a lock holder bracket which is secured to the lock holder plate,
wherein the lock holder bracket comprises a locking pin, a central piece, and a connecting pin,
wherein the central piece is equipped with a projection in a direction of a longitudinal axis of the central piece, and
wherein the lock holder is designed in at least two parts.

2. The lock holder according to claim 1, wherein the lock holder bracket is non-detachably secured to the lock holder plate.

3. The lock holder according to claim 1, wherein the lock holder bracket comprises a mounting web arranged parallel to the central piece.

4. The lock holder according to claim 3, wherein the mounting web comprises a flat contact surface corresponding to the lock holder plate.

5. The lock holder according to claim 3, wherein the mounting web comprises at least one mounting element integrally formed on the mounting web.

6. The lock holder according to claim 1, wherein the projection forms a contact surface for a catch of the motor vehicle door lock.

7. The lock holder according to claim 6, wherein the projection and the central piece are arranged on a common plane to form a contact surface for the catch.

8. The lock holder according to claim 6, wherein the projection and the central piece form a flat contact surface for the catch.

9. The lock holder according to claim 1, wherein the lock holder bracket is designed as one piece.

10. The lock holder according to claim 1, wherein the locking pin has a cylindrical cross-sectional shape, and the central piece, the connecting pin and the mounting web have a square cross-sectional shape.

11. The lock holder according to claim 3, wherein the mounting web extends along the lock holder plate and abuts the lock holder plate.

12. The lock holder according to claim 3, wherein the lock holder bracket is connected to the lock holder plate using the mounting web.

13. The lock holder according to claim 1, wherein the projection is configured to extend from the central piece beyond the locking pin to engage with a catch arm of the catch.

14. The lock holder according to claim 1, wherein the projection has a cross-sectional shape corresponding to the central piece.

15. A motor vehicle lock comprising:
the lock holder according to claim 1, and
a catch, wherein the projection forms a contact surface for the catch.

16. The motor vehicle lock according to claim 15, wherein the projection and the central piece are arranged on a common plane in relation to the contact surface of the catch to form a common contact surface for the catch.

17. The motor vehicle lock according to claim 15, wherein the projection and the central piece form a flat contact surface as the contact surface for the catch.

18. The motor vehicle lock according to claim 15, wherein the projection is configured to extend from the central piece beyond the locking pin to engage with a catch arm of the catch.
